(19) United States
(12) Patent Application Publication
(10) Pub. No.: US 2003/0149610 A1
(43) Pub. Date: Aug. 7, 2003

(54) Method of strategic planning

(76) Inventors: Christopher G. Rowan, Coronado, CA (US); Sharnaz Motakef, Carlsbad, CA (US); Indradeep Ghosh, San Diego, CA (US)

Correspondence Address: Cymer, Inc., Legal Department - MS/1-2A, 16750 Via Del Campo Court, San Diego, CA, 92127-1712, US

(21) Appl. No.: 10/068,429

(22) Filed: Feb. 6, 2002

(51) Int. Cl. G06F 17/60

(52) U.S. Cl. 705/10

(57) ABSTRACT

A method for strategic planning by an entity includes assessing a current status of the entity to use as a basis to establish a development direction for the entity, seeking opportunities for the entity in a market and establishing a vision for the entity. The method also includes performing an analysis of the market consistent with the vision to determine a set of profitable market segments from the opportunities. The method also includes establishing a marketing plan consistent with the vision to change the current status of the entity and prioritizing a product portfolio based on the marketing plan. The method implements a course of action consistent with the vision and the marketing plan to move the entity from the current status to the development direction.

### BACKGROUND OF THE INVENTION

This invention relates to a method of business development.

A business, whether new or established, often struggles to grow over time. As the business does become larger in terms of employees and revenue, often a lack of consistency develops in the every day business decisions that are made from employee to employee.

There have been a number of marketing and management models and tools to assist businesses in growing and becoming more profitable. One such tool, the Porter Analysis, described in March-April 1979 Harvard Business Review article, “How competitive forces shape strategy” by Michael E. Porter, models a business environment as five competing forces. They include buyers, suppliers, industrial competitors, new entrants and substitutes (products or services). If the business understands how it stands in relation to these competing forces, then the business has a better chance of charting a course for the future development. Other models, such as the Treacy and Wiersema model found in the January-February 1993 Harvard Business Review article, “Customer Intimacy and Other Value Disciplines” by Michael Treacy and Fred Wiersema, describes the value propositions a business can have such as customer intimacy, operational excellence and product leadership.

Still other models describe the core competencies a business uses to be competitive. See for example, the May-June 1990 Harvard Business Review article, “The Core Competence of the Corporation” by C. K. Prahalad and Gary Hamel.

### SUMMARY OF THE INVENTION

In one aspect, the invention is a method for strategic planning by an entity. The method includes assessing a current status of the entity to use as a basis to establish a development direction for the entity, seeking opportunities for the entity in a market and establishing a vision for the entity. The method also includes performing an analysis of the market consistent with the vision to determine a set of profitable market segments from the opportunities. The method also includes establishing a marketing plan consistent with the vision to change the current status of the entity and prioritizing a product portfolio based on the marketing plan. The method implements a course of action consistent with the vision and the marketing plan to move the entity from the current status to the development direction.

In another aspect, the invention is an apparatus that includes a memory that stores executable instructions for strategic planning and a processor. The processor executes the instructions to assess a current status of the entity to use as a basis to establish a development direction for the entity, to seek opportunities for the entity in a market and to establish a vision for the entity. The vision includes a value proposition, a mission statement and a set of desired core competencies. The processor also executes instructions to perform an analysis of the market consistent with the vision to determine a set of profitable market segments from the opportunities. The processor executes instructions to establish a marketing plan consistent with the vision to change the current status of the entity. The processor executes instructions to prioritize a product portfolio based on the marketing plan and to implement a course of action consistent with the vision and the marketing plan. The course of action moves the entity from the current status to the development direction.

In still another aspect, the invention is an article that includes a machine-readable medium that stores executable instructions for strategic planning. The instructions cause a machine to assess a current status of an entity to use as a basis to establish a development direction for the entity, to seek opportunities for the entity in a market, and to establish a vision for the entity. The vision includes a value proposition, a mission statement, and a set of desired core competencies. The instructions cause a machine to perform an analysis of the market consistent with the vision to determine a set of profitable market segments from the opportunities. The instructions cause a machine to establish a marketing plan consistent with the vision to change the current status of the entity. The instruction cause a machine to prioritize a product portfolio based on the marketing plan and to implement a course of action consistent with the vision and the marketing plan. The course of action moves the entity from the current status to the development direction.

### BRIEF DESCRIPTION OF THE DRAWINGS

FIG. 1 is a flow chart of a process for strategic planning.

FIG. 2 is a flow chart of a subprocess for seeking market opportunities.

FIG. 3 is a flow chart of a subprocess of establishing a vision for the business.

FIG. 4 is a flow chart of a subprocess for determining value proposition for the business.

FIG. 5 is a diagram depicting a spreadsheet for ranking disciplines by the business versus competitors.

FIG. 6 is a diagram depicting a spreadsheet for determining value proposition using a quantitative analysis.

FIG. 7 is a flow chart of a subprocess for establishing a business mission.

FIG. 8 is a flow chart of a subprocess for determining product core competencies.

FIG. 9 is a flow chart of a subprocess for determining process core competencies.

FIG. 10 is a flow chart of a subprocess for performing a market analysis.

FIG. 11 is a flow chart of a subprocess for mapping market opportunities.

FIG. 12 is a diagram illustrating an example of the process establishing an opportunity map for the laser market.

FIG. 13 is a diagram illustrating an example of the process establishing an opportunity map for an excimer laser market.

FIG. 14 is a diagram illustrating an example of the process establishing an opportunity map for the metrology laser market.

FIG. 15 is a flow chart of a subprocess for establishing a market plan.

FIG. 16 is a general market assessment checklist.

FIG. 17 is a Porter analysis table.

FIG. 18 is a detailed market assessment checklist.

FIG. 19 is a flow chart of a subprocess for a product life cycle.

FIG. 20 is an example of the process for establishing a table of “must have companies” in an acquisition example of the process.

FIG. 21 is an example of the process for establishing a table of “nice to have companies” in an acquisition example of the process.

FIG. 22 is a flow chart of a subprocess for a prioritizing.

FIG. 23 is a flow chart of a subprocess for a merger and acquisition of a target firm.

FIG. 24 is a block diagram of a computer system on which the process of FIG. 1 may be implemented.

FIG. 25 is a flow chart of a parallel process for strategic planning.

### DETAILED DESCRIPTION

A business that lacks a strategic business strategy that permeates through an organization is plagued by ineffective business behaviors. These behaviors include inconsistent communication, employees working on competing goals, arguments over resource allocation, longer cycle times, rework of product, inability to effectively delegate and a de-optimized product portfolio.

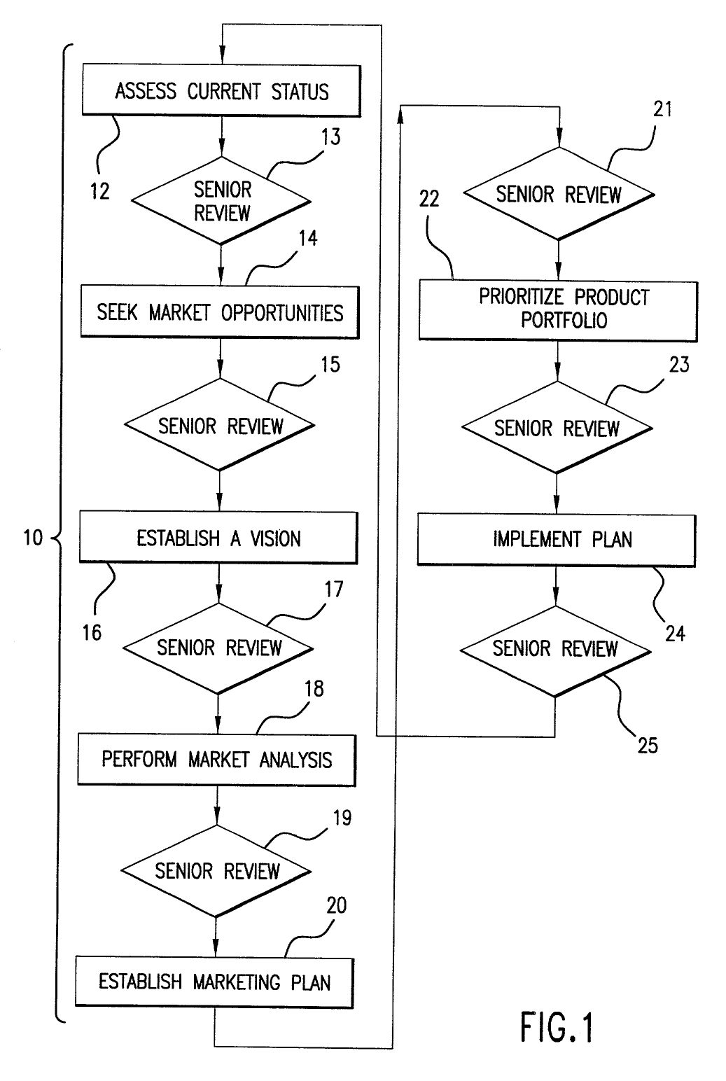

Referring to FIG. 1, the business uses process 10 in business development to have consistency of purpose. Process 10 includes a series of actions, e.g., assessing current status (12), seeking market opportunities (14), establishing a vision (16), preforming market analysis (18), establishing a marketing plan (20), assessing current status (22), and implementation. Each of these actions is preferably followed by a review action generally by a senior team of management. Process 10 can be performed in a reiterative manner.

By following process 10, the business plan iteratively and continuously leverages expertise of senior management. Process 10 is a systematic way to scan for market opportunities to increase overall efficiency and to reduce the cost of planning.

Process 10 is performed by an entity. An entity can be any business or company including a partnership, a corporation, a limited partnership, etc. The entity can be a “for profit” or a “not for profit” entity. The benefits of process 10 increases the greater the number of employees the entity has. In this description, business and entity are interchangeable.

Process 10 optimizes a business' resources (e.g., employees, capital, etc.) and establishes a course of action for the business to follow so that the business can leverage its resources to accomplish its business goals. Some of these business goals may be the acquisition of another business or a determination of which markets to compete in or both. Process 10 allows the employees of a business to understand the underlying goals of the business and to make those decisions necessary so that all employees in the business proceed in the same direction. By following process 10, each employee performs actions consistent with one another to reduce inefficiencies that result from competing purposes. Thus, process 10, provides a well-thought out strategy through proven analytical tools, that is readily communicated through consistent documentation and through a dissemination plan. The strategy is understood by every one in the organization and is actionable through prioritized action items.

As will be explained below, process 10 includes processing actions to achieve consistency through everyday business activities. Process 10 is a continuous process. Each action within process 10 represents a reiterative subprocess. Each action has an input and an output. The output of one action is the input of a subsequent action. The output of each action is reviewed by senior executives to ensure that the result of each processing action is in line with the overall business objectives.

Process 10 assesses (12) a current status of the business. A starting point is established as a basis to develop the business from in order to establish a direction for the business to head-in. A cross-functional team, representing different functional areas of the business, is established to document a current mission statement for the business. The mission statement codifies, the business values, the value proposition, and the current marketing strategy of the business. Most of the information in the mission statement may already exist or be documented by the business. That information, which was not previously documented, is determined through an exchange amongst cross-functional team members. The results of the cross-functional teams assessment is passed on to a senior staff for review and approval (13). When process 10 is repeated all the information needed for this action (e.g., mission statement, value proposition etc.) will be already documented as products of other processing actions within process 10. However, a cross-functional team is necessary to be responsible for the consolidation of this information.

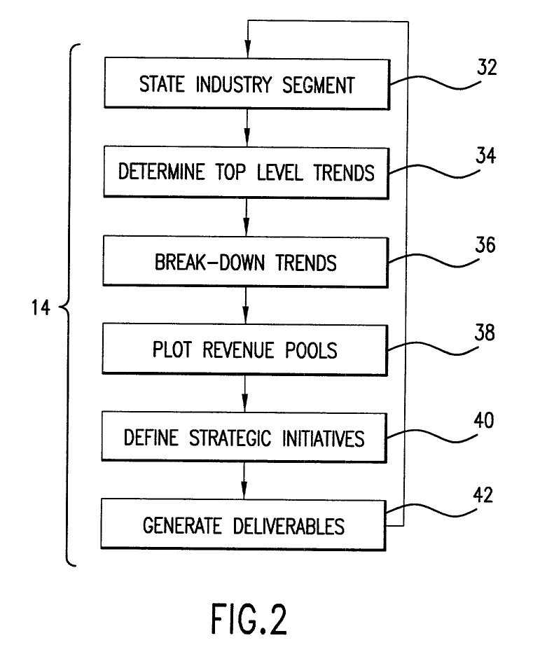

Referring to FIG. 2, process 10 seeks (14) market opportunities available for the business (FIG. 1). An exemplary implementation of seeking market opportunities (14) seeks to establish industry trends. Process 14 determines the industry trends and the revenue pools in the industry. Industry trends include the major industry trends that describe the horizontal and vertical supply chain structure and trends within each industry segment. The industry trend information is compiled from market research firms, investment banks, employees, and conferences.

To determine the industry trends, process 14 determines (32) the industry segments that the business is a part of. For example, an electronics supply chain includes a semiconductor industry, a capital market and material industry and a subsystems industry. The segments within the semiconductor industry include a consumer electronics segment, a communications segment, and a PC segment.

Precess 14 determines (34) the top-level trends in the industry. These trends are provided by marketing research groups and senior executives and forecast the future of the industry. For example, in the consumer electronics segment, the marketing research groups identify that the market driver for customers to purchase a product changes from the technology in a product to the features in a product. After the industry segments have been identified and the top-level trends are identified, process 14 breaks-down (36) the trends to lower level industry segments. Again, market research data is used to determine the trends in the lower level segments.

Once the industry trends have been established at all levels, process 14 plots (38) the revenue pool at each lower level segment based on marketing forecasts. Plotting the revenue pool occurs using conventional automated or manual techniques. The revenue pools are defined as the total revenues earned in an industry at all points in an industry's value chain. The revenue pool will be deeper in some segments of the value chain than in other segments.

Process 14 defines (40) strategic initiatives for the business by focusing on the most profitable business segments. Process 14 assigns an owner (organization or individual) to the initiative. The owner is responsible throughout process 10 to achieve, monitor and report success of the strategic initiative.

Process 14 generates (42) deliverables. The deliverables from process 14 include a strategic initiatives owner list, revenue pool and a industry trend assessment. Process 14 is repeated periodically as required.

Process 14 is conducted by a second cross-functional team. The second crossfunctional team includes a vice-president (VP) of marketing, a new business manager, a business analyst, and a VP of sales. The second cross-functional team correlates the marketing forecast information by industry and by industry segment. The second cross-functional team assigns the strategic initiatives to the owners within the business. The second cross-functional team prepares a report for the senior staff outlining the market opportunities available in the market. The senior staff reviews (15) the final product.

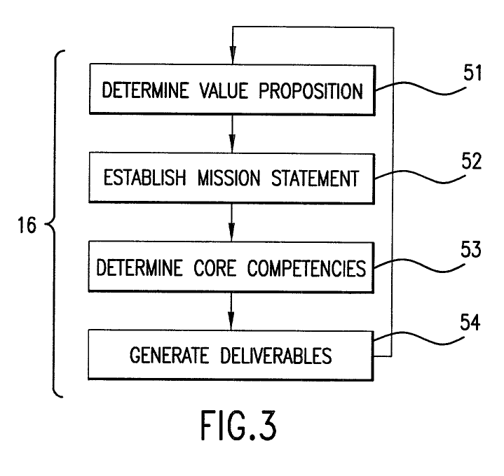

Referring to FIG. 3, process 10 establishes (16) a vision for the company (FIG. 1). An exemplary implementation of establishing a vision (16) determines the mission, values and desired competencies of the business. Process 16 determines (51) the value proposition of the business. Process 16 establishes (52) a mission statement for the business. Process 16 determines (53) the desired core competencies of the business.

Process 16 generates (54) deliverables. The deliverables include products developed in each of the actions (51-53) described below. A cross-functional team performs process 16. The cross-functional team includes VP of marketing, VP of sales, VP of technology, VP of manufacturing, VP of human resources, VP of operations, the president, Chief Executive Officer (CEO), Chief Operating Officer (COO) and Chief Technology Officer (CTO). Process 16 is repeated periodically as required.

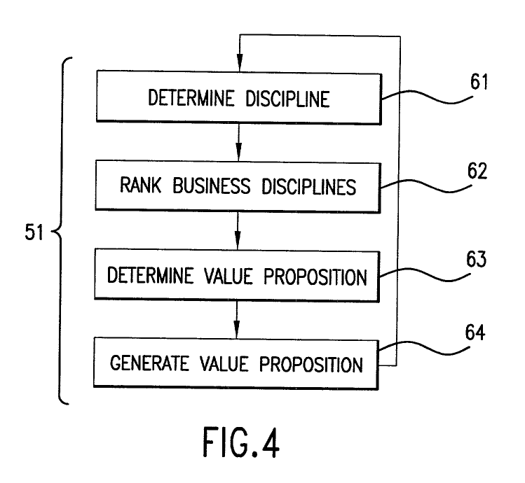

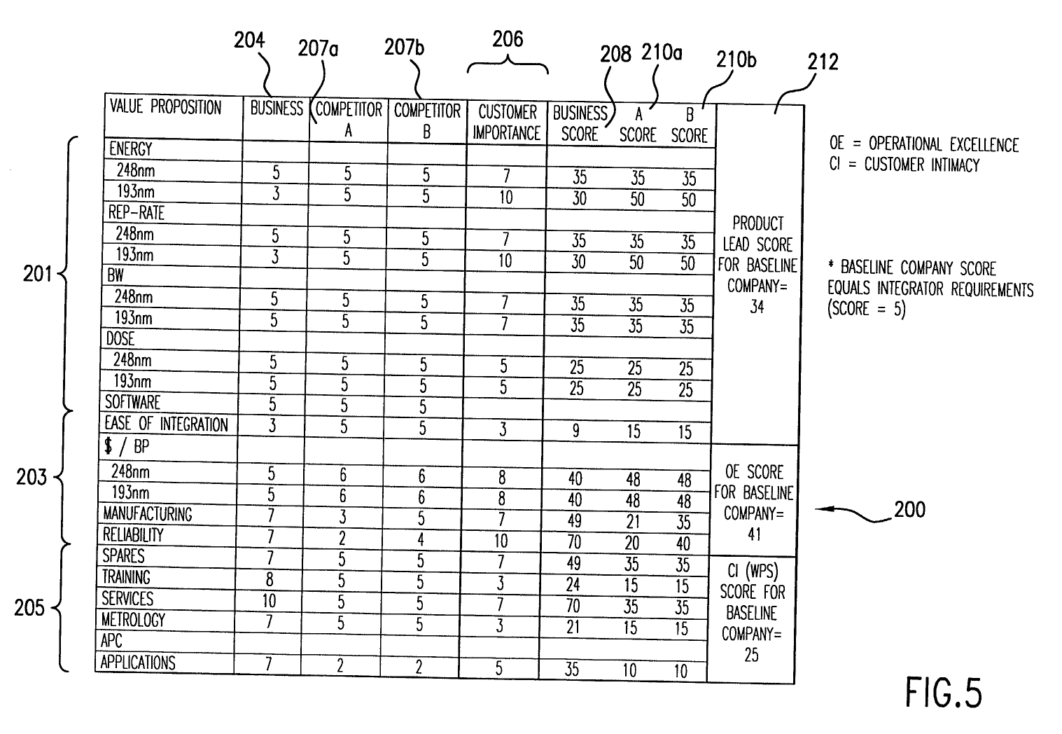

Referring to FIG. 4, process 51 determines the value proposition of the business. A business may have a number of value propositions including product leadership, customer intimacy, and operational excellence. For example, a business may have product leadership as a value proposition. In this case, the business wants to have the “best product” that customers will pay a premium to purchase. In another value proposition, the business wants customer intimacy. To achieve customer intimacy, the business wants the “best total solution” to solve a customer's broader needs or problems so that the business can share in the benefit. Another value proposition the business may desire is operational excellence. To achieve operational excellence, the business wants to have the “best total cost” by achieving a low cost position on product service and support. Other value propositions are possible, such as any combination of the value propositions previously mentioned.

Process 51 determines (61) the discipline needed to perform each of the value propositions. Each value proposition is characterized by different categories such as core processes, organization, culture, management systems and information technology. For example, the product leadership value proposition focuses on core processes that encourage innovation, commercialization and market exploitation and have disjointed work procedures. The organization is ad-hoc, organic and cellular with high-skilled employees in loose-knit structures. The culture is concept and future driven and promotes experimentation and an “out of the box” mindset. The management systems are decisive, risk orientated and reward individuals' innovation capacity. The management systems also promote product life-cycle profitability. The information technology has person-to-person communications and technologies that enable cooperation and knowledge management. The disciplines under product leadership in the semiconductor industry would focus on the physical characteristics of the product including doping, ease of integration, and software.

In the categories, under the operational excellence value proposition, the core processes are based on product delivery and a basic service cycle. The organization has centralized functions with highly skilled individuals at the core of the organization. The culture has disciplined teamwork and process focused with a conformance and “one size fits all” mindset. The management systems promote command and control with compensation fixed to cost and quality. The management systems track transactional profitability. The information technology is integrated low cost transactional systems that have remote and mobile technologies. The disciplines that would fall under operational excellence include manufacturing, reliability, spares and training.

In the customer intimacy value proposition, the discipline includes core processes that encourage client acquisition and development with solution development and flexible and responsive work procedures. The organization is entrepreneurial client teams with highly skilled individuals in the field. The culture is client and field driven having a “Have it your way” mindset. The management systems are revenue and “share of wallet” driven. Rewards are based on client feedback and lifetime value of client analysis. The information technology has customer databases linking internal and external information. The knowledge bases are built around expertise.

Referring FIG. 5, process 51 ranks (62)(FIG. 4) a set of business disciplines versus the business and its competitors using a spreadsheet 200. The spreadsheet 200 can be run on any type of computer system. Results of using the spreadsheet can be rendered in electronic form, e.g., on a computer monitor or in physical form, e.g., via a hard copy print out from a printer.

The business disciplines 202 are arranged by value propositions for product leadership 201, operational excellence 203 and customer intimacy 205. A customer rates on a scale of 0 to 10 the importance of each discipline in a customer importance column 206 where 10 is the most important and 0 is not applicable. The customer also rates on a scale from 1 to 10 the business in a business column 204 and the competitors in competitor columns (e.g., competitor A column 207a and competitor B column 207b). 0 to 4 on the scale is below requirements, 5 meets requirements, and 6-10 is above requirements.

A business score column 208 is determined by multiplying the customer importance column 206 by the business column 204. A competitor A score column 210a is determined by multiplying the competitor A column 207a by the customer importance column 206. Likewise, a competitor B score column 210b is calculated by multiplying the competitor B column 207b by the customer importance column 206. A company baseline is calculated for each value proposition by adding the customer importance scores and multiplying by a score of 5 and dividing by the number of disciplines in each value proposition. For example, the customer importance scores for the operation excellence disciplines adds up to be 33 (8+8+7+10=33) and the number of disciplines are 4. Therefore the operational baseline score is 41.

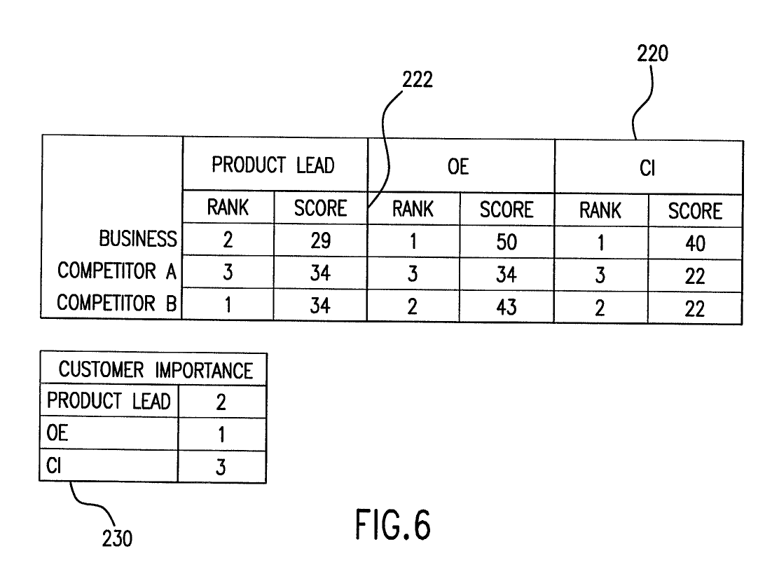

Referring to FIG. 6, process 51 determines (63) the value proposition rankings through a quantitative analysis using spreadsheet 220 (FIG. 4). Each score is determined by adding up the scores for each value proposition by business or competitor and dividing by the number of disciplines for the value proposition. For example, the score 222 for the business under the product lead value proposition is calculated by adding-up the scores for each of the disciplines under the product lead value proposition for the business and dividing by the number of disciplines or

(35+30+35+30+35+35+25+25+9)/9=29.

Speadsheet 230 ranks the value propositions based on the customer importance. Since product leadership was ranked 34, operational excellence was ranked 41, and customer intimacy was ranked 25, the rankings are as follows: operational excellence is ranked 1st, product leadership is ranked 2nd, and customer intimacy is ranked 3rd.

Process 51 is performed for all major customers of the business. The results quantify the business' standing versus its competitors for each of the value propositions and also ranks the customers preferences to each of the values propositions. Spreadsheet 120 and spreadsheet 130 for each of the major customers is the output.

Process 51 generates (64) a value proposition report for use in establishing a mission statement in process 52. Process 51 is repeated periodically as required.

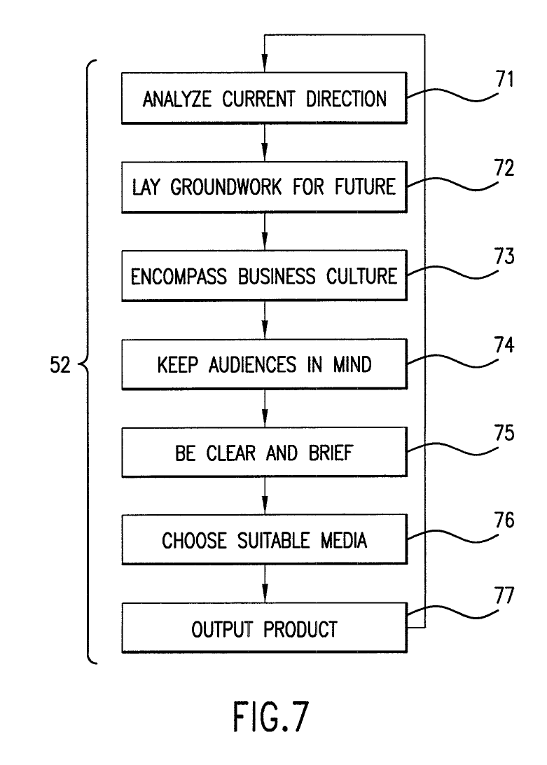

Referring to FIG. 7, process 16 establishes a new mission statement and values of the business through process 52 (FIG. 3). A mission statement from a business provides a purpose around which the employees and other stakeholders can rally. Without clear direction, it is difficult for stakeholders to know or care about where they are heading. Management plans should be based on the mission statement. The process the organization goes through to determine its mission statement and the way it demonstrates its commitment to those values is important to the success of the business. The mission statement should encompass all stakeholders and address all the needs of the organization and its people. The needs include the physical and economic well-being, respect and dignity, growth, development and spiritual needs of its people. The mission statement articulates a business' strategy and aligns people, technology and business systems. Process 52 accomplishes these objectives.

Process 52 analyzes (71) the current direction of the business. Process 52 lays the groundwork (72) for the future of the business. Process 52 encompasses (73) the business culture. Process 52 keeps (74) audiences in mind. These audiences include shareholders, customers, and employees. Process 52 ensures (75) a clear and brief mission statement. Mission statements that are short and concise stick in peoples' minds easier than lengthy documents. Process 52 chooses (76) a suitable media to convey the mission statement. Process 52 generates (77) the mission statement and the proposed means of displaying the mission statement. The mission statement is reviewed by senior management before being displayed prominently by the business. The mission statement is used as an input to process 53 in determining core competencies. Process 52 is repeated periodically as required.

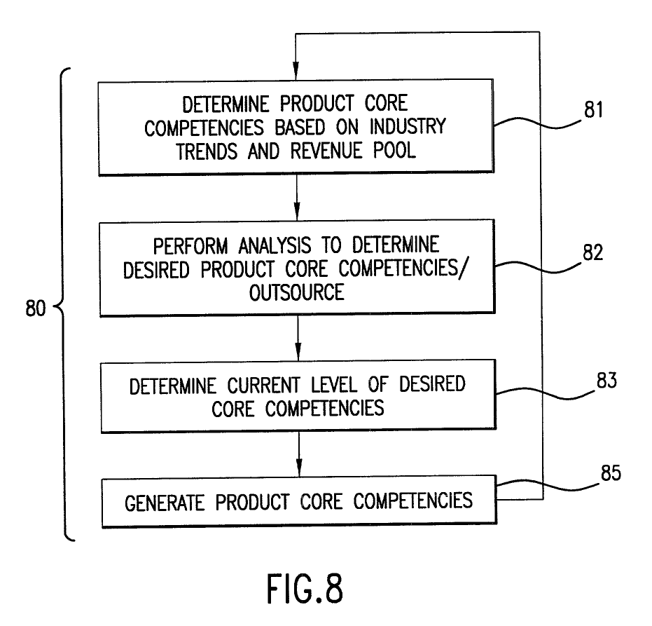

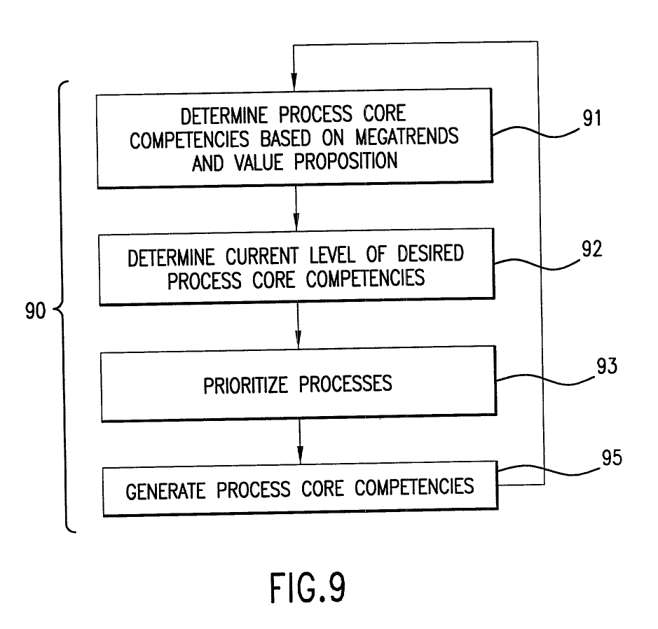

Referring to FIGS. 8 and 9, process 16 chooses (53) which desired core competencies the business must possess to move forward by using a process 80 and a process 90. Examples of core competence are the skills, experience, and knowledge within a business that results in the business performing one or more processes at a high standard. The importance of the core competence to strategy making rests with the added capability it gives the business in pursuing a particular market opportunity and the competitive edge it yields in the marketplace. The importance of the core competence to strategy making also rests with its potential for being a cornerstone of strategy. The objective of process 80 and process 90 is to determine which core competencies should be developed by the business in order to compete in the market.

Referring to FIG. 8, process 80 determines (81) product core competencies based on industry trends and revenue pools. Process 80 performs an analysis to determine (82) which product core competencies to develop in the business and which product core competencies to outsource. Process 80 also determines (83) the current level of level of desired core competencies within the business. Process 80 generates (85) a list of desired product core competencies. Process 80 is repeated periodically as required.

Referring to FIG. 9, process 90 determines (91) process core competencies based on the industry trends and value proposition. Process 90 determines (92) the current level of desired process core competencies. Process 90 also prioritizes (93) the process core competencies. Process 90 generates (95) a list of desired process core competencies. Process 90 is repeated periodically as required.

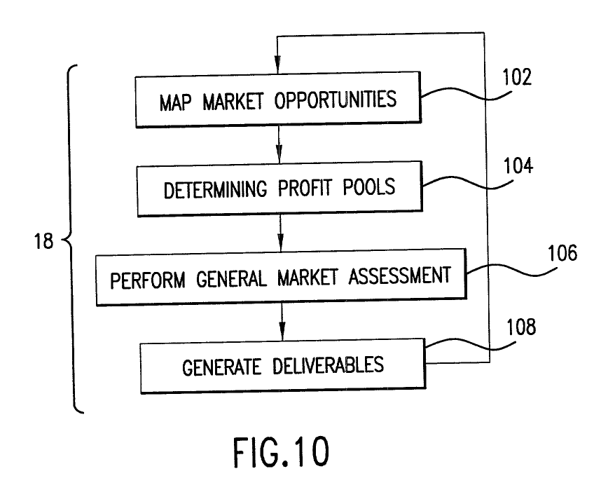

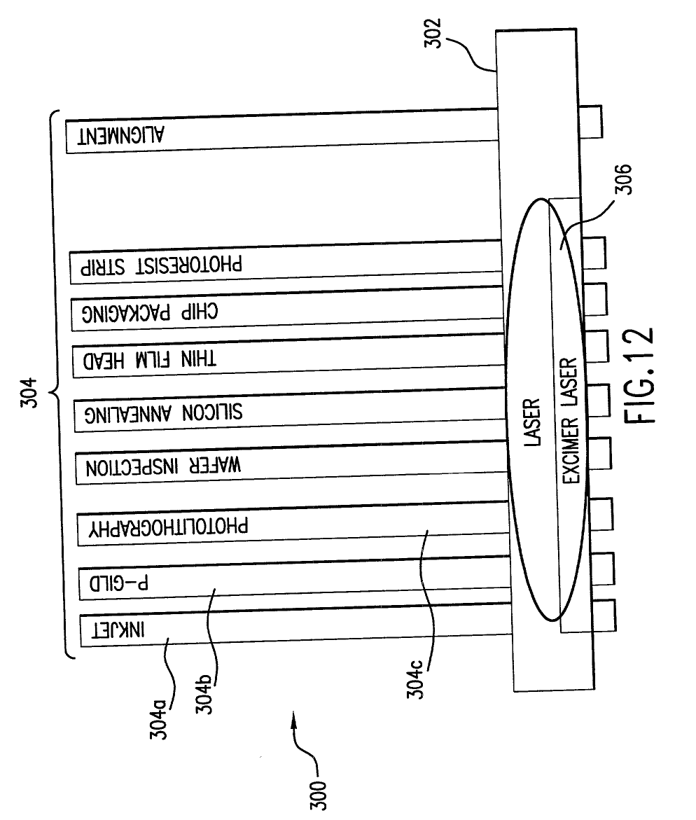

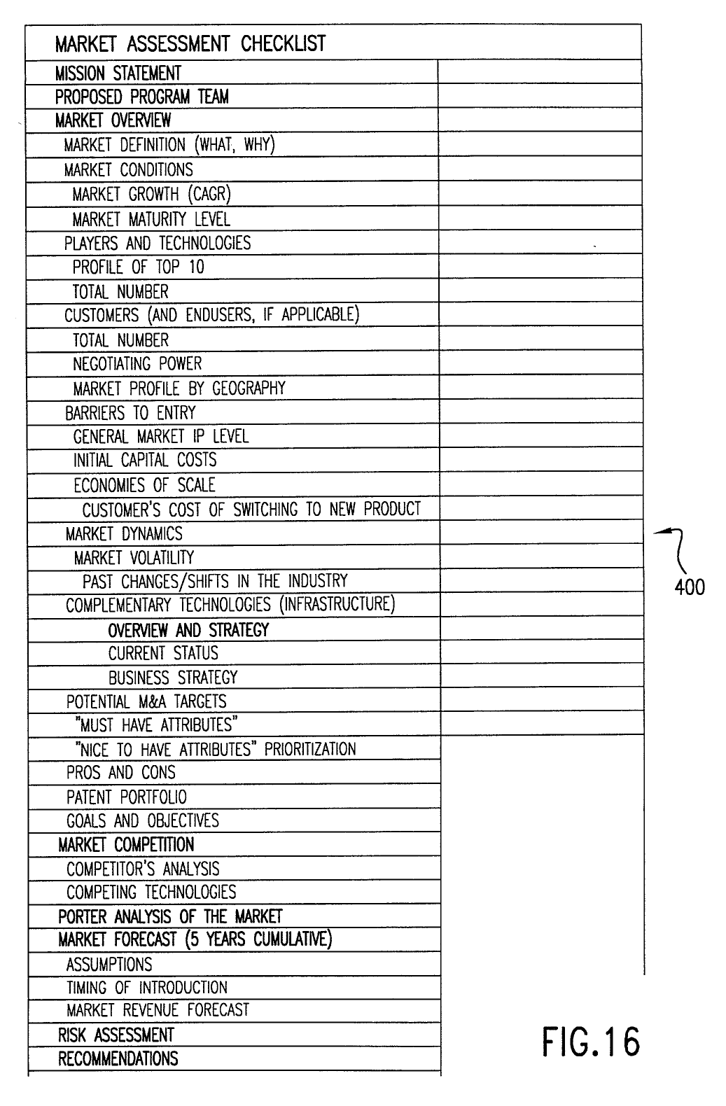

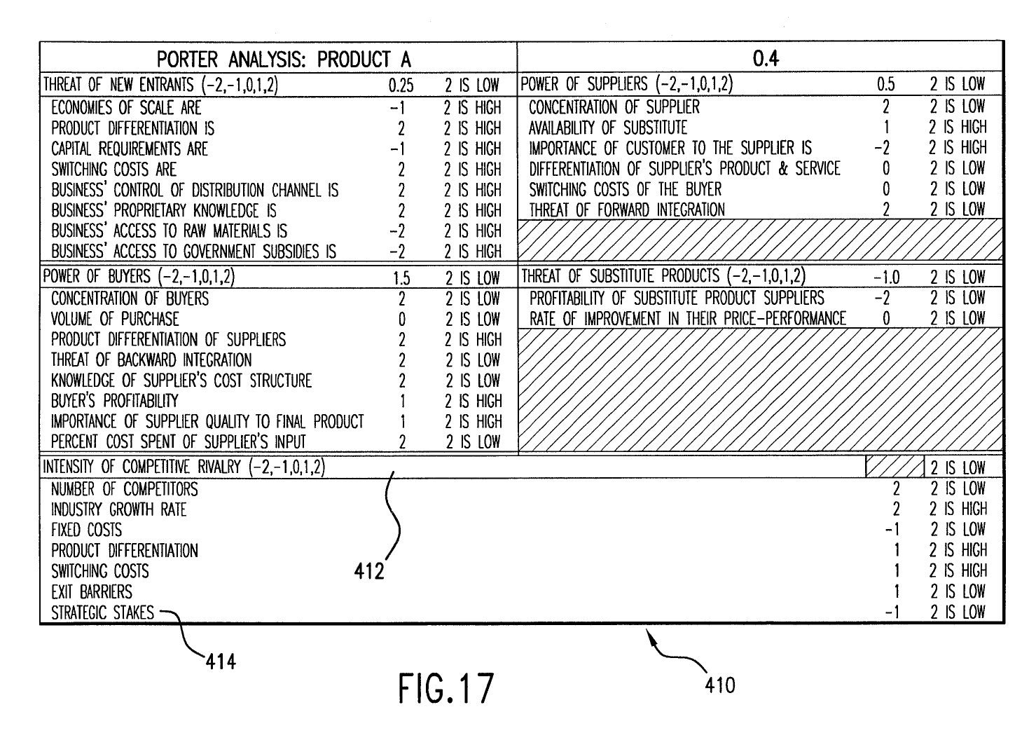

Referring to FIG. 10, process 18 performs a market analysis. An exemplary implementation of performing the market analysis maps the market in terms of profitability (18). Process 18 maps (102) the market opportunities available. Process 18 determines (104) the profit pools available in the market. Process 18 performs (106) a general market assessment. Process 18 generates (108) deliverables to be reviewed (19) by senior management (FIG. 1). The deliverables from process 18 typically include a market opportunity map (FIGS. 12-14), a profit chart, a general market assessment checklist (400) (FIG. 16) and a Porter analysis table (FIG. 17). Process 18 is repeated periodically as required. Process 18 is performed by a cross-functional team that includes a VP of marketing, a new business development manager, a director of marketing and a business analyst.

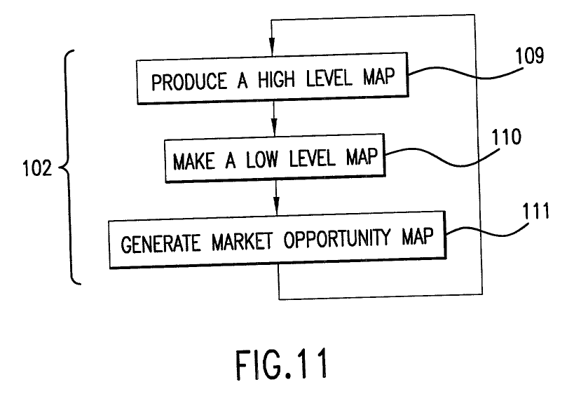

Referring to FIG. 11, process 102 maps a marketing opportunity map by producing (109) a high level vertical and horizontal market opportunity map for the business/product and by making (110) a lower level market opportunity map for each core competence required by the business/product. The purpose of the market opportunity map is to apply the core competency to horizontal and vertical food chains and to apply technical and market knowledge to new markets.

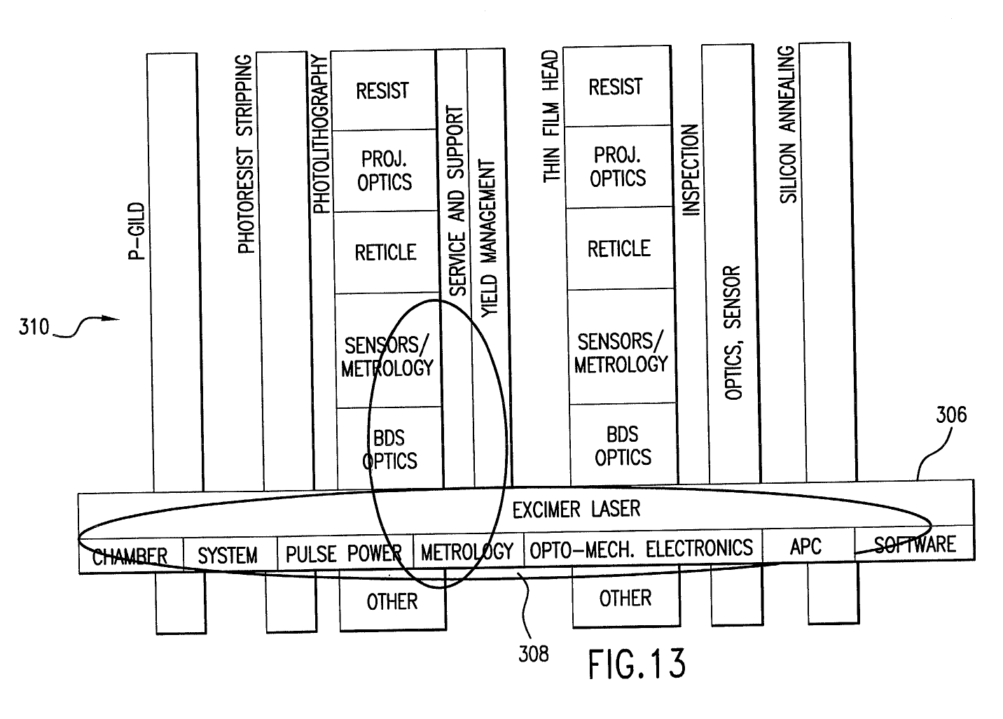

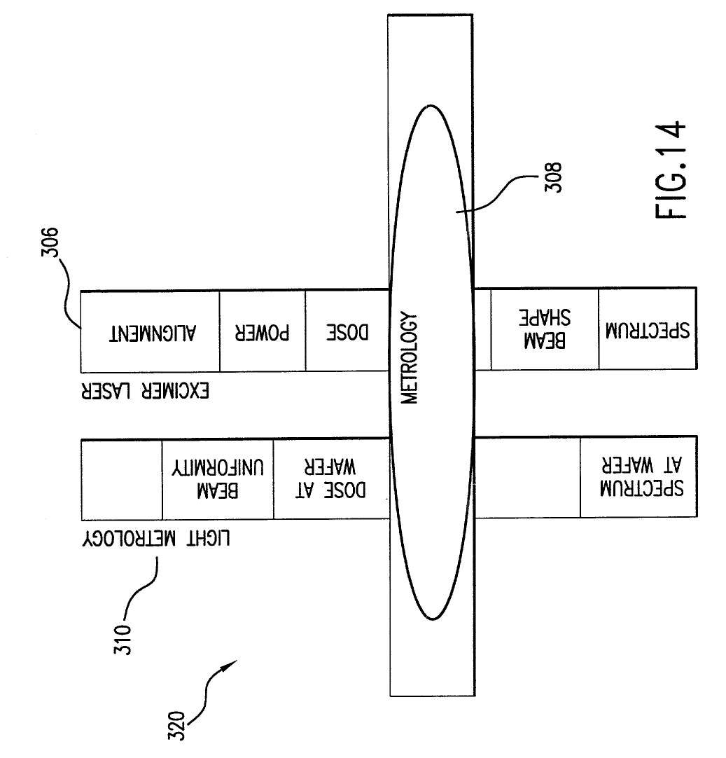

Referring to FIGS. 12-14, for example, a laser market opportunity map 300 has a laser core competency 302 and is mapped over the horizontal food chain 304 (e.g., Inkjet 304a, P-Grid 304b, Photolithography 304c, etc.). Laser competency 302 is made-up of a vertical food chain that has an excimer laser segment 306. In FIG. 13, excimer laser segment 306 can be further broken-down into other vertical chains like a metrology segment 308. In FIG. 14, metrology segment 308 is mapped with other similar technologies like excimer laser segment 308 and light metrology segment 310 that use metrology. Therefore, cutting across the vertical and horizontal chains, allows a business to fully understand how to exploit its core competencies within a market.

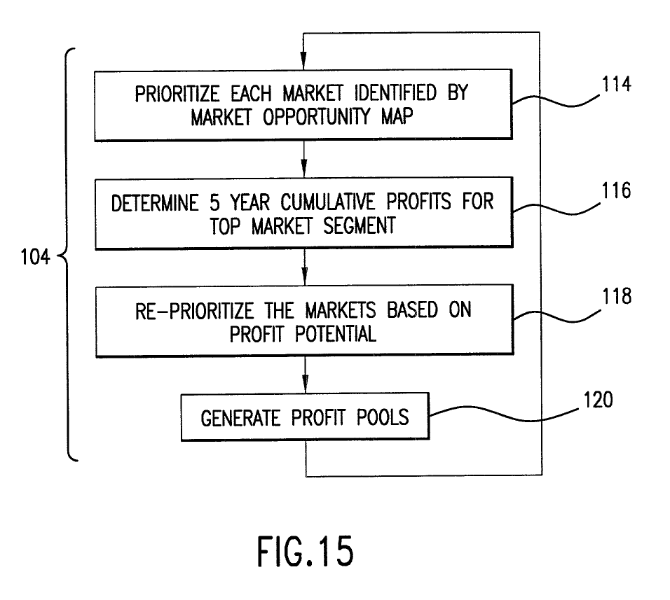

Referring to FIG. 15, process 104 determines the profit pools in the market. Process 104 prioritizes (112) each market identified in the market opportunity map. Process 104 determines e.g., the five-year cumulative profits for the top market segment. Process 104 reprioritizes (118) the markets based on e.g., the five-year cumulative profits. Process 104 generates (120) profit pools. Process 104 is repeated periodically as required.

Referring to FIGS. 10 and 16, process 18 performs (106) the general market assessment. An exemplary implementation of performing the general assessment is by completing a general market assessment checklist 400 and performing a Porter analysis and general market assessment report. General market assessment checklist 400 is a list of items that are completed in order to have a complete general market assessment. These items include a mission statement, market overview, market competition, porter analysis, market forecast, risk assessment and company overview and strategy.

Referring to FIG. 17, the theory behind the Porter analysis is that the collective strength of the five competitive forces determines the ability of firms in an industry to earn on average rates of return on investment in excess of the cost of capital. The strength of the five forces varies from industry to industry and can change as an industry evolves. Porter analysis table 410 is used to measure the business' competitive environment with regard to the five competitive forces for a product. The table 410 is divided by a competitive force section 412 each representing one of the five Porter competitive forces. Each section 412 is made up of a subentry 412. Each subentry is scored either −2, −1, 0, 1, or 2. Products with scores greater than zero are recommended for further analysis.

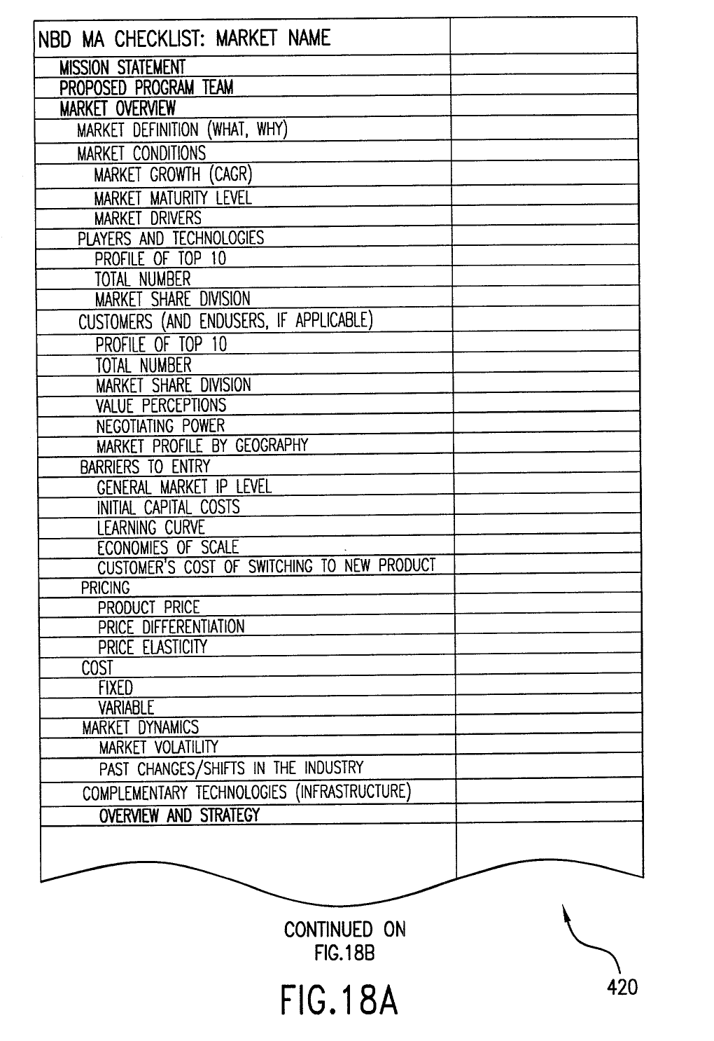

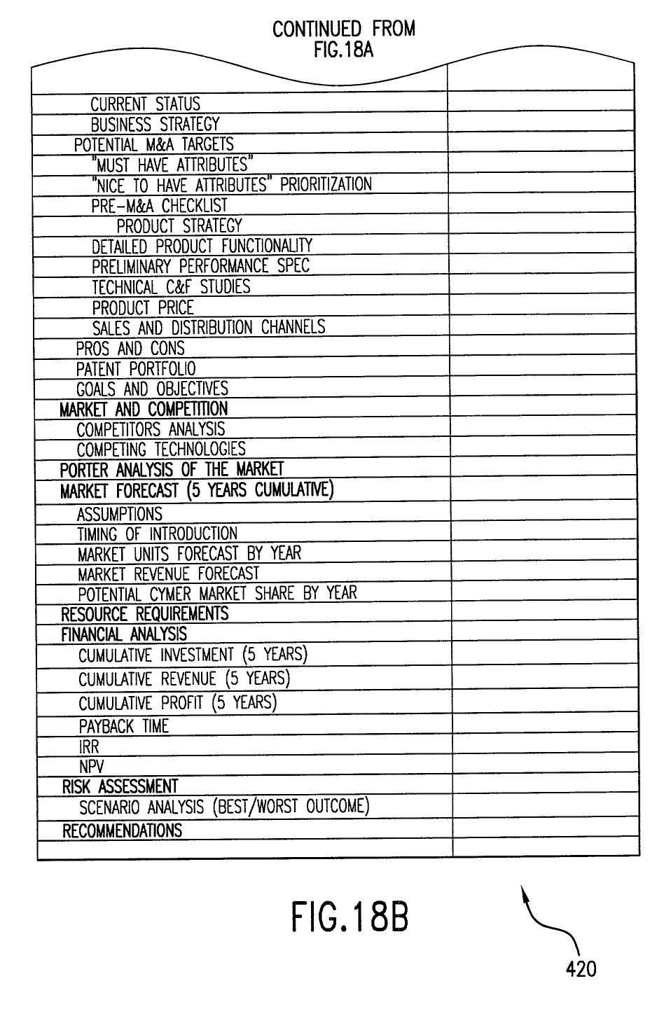

Referring to FIG. 18, process 10 establishes (20) a marketing plan. An exemplary implementation of establishing the marketing plan is derived from developing a detailed market assessment and determining a product life cycle effect on a product portfolio. Process 10 also establishes (20) a marketing plan by analyzing the potential target businesses for acquisition. A detailed market assessment checklist 420 allows the business to focus on particular marketing area.

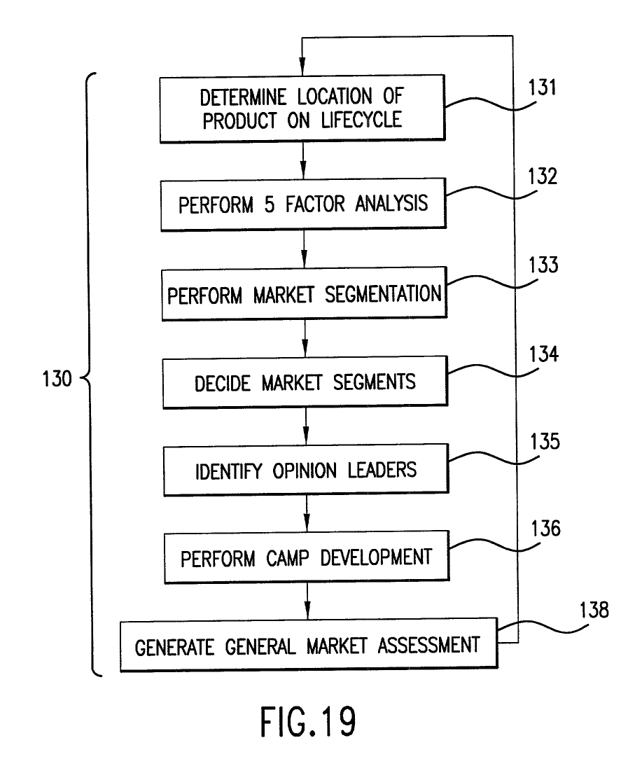

Referring to FIG. 19, where a product is in its life cycle affects how a marketing plan is formed. Therefore, the marketing strategy should be dependent on the product life cycle stage. The product life cycle has five stages from inception to death: innovators, early adopters, early majority, late majority and laggards. In the innovators stage, the marketing strategy for products should be developed for customers who are intrigued by any fundamental advance in technology and will take any technology for technology sake. These customers like to alpha-test new products and can ignore the missing elements, but want no-profit pricing.

In the early adopters stage, the marketing strategy is developed for those customers that are driven by the vision of a dramatic competitive advantage through revolutionary breakthroughs. These customers have great imagination for strategic applications. However, these customers are not price-sensitive. These customers also demand a high degree of customization but have had previously integrated or created standards in the industry.

In the early majority stage, the marketing strategy for products is developed for customers that want sustainable productivity improvement through evolutionary change. These customers are astute managers of mission-critical applications and understand real-world tradeoffs. These customers also focus on proven applications, want to see the solution in the product and rely on third parties and suppliers for technical resources.

In the late majority stage, a marketing strategy for products is developed for customers that want to stay even with the competition, are risk adverse, are price-sensitive and need completely pre-assembled solutions. In the laggard stage, the marketing strategy for products is aimed at customers that are driven by the status quo, disbelieve productivity and improvement arguments and oppose early adoption of a technology.

Process 130 is an exemplary implementation of a product life cycle on a marketing plan. Process 130 determines (131) where a product is in its life cycle. Process 130 performs (132) five factors of analysis of the new product or technology. The first factor is the relative advantage to current state. This factor focuses on a description of the customer's business strategy, the customer's customer and how the customer adds value. In addition, a description of the customer's application requirements, how it relates to adding value and how those needs are met by the current/alternative technology. Also, an understanding of how the proposed technology enables the customer to solve their problem and add value to their customer is also described. The second factor determines the compatibility to the existing infrastructure. This factor focuses on what the adoption cost for the proposed technology is in terms of time and money and the whether the current infrastructure can support the proposed technology. The third factor determines how complex the proposed technology is and whether there is enough knowledge on the customer side. The fourth factor determines whether it is easy for early adopters to try the product. The fifth factor determines the ability for a pragmatist, who will copy the product, to observe the results and whether the process development/verification results are publishable for the benefit of the pragmatist who may not have sizeable research and development funding or resources.

Process 130 performs (133) a market segmentation. Market segmentation is a group of customers in the market that share common desires, needs and buying patterns who, when presented with a set of options, will act in a similar manner. The market segment can be a category, a market or a single customer. Multiple segments can co-exist in a market at any given time. In general, the marketing segments can change over time due to needs and behavior evolution, and as customers redefine themselves, and markets segments themselves evolve.

Process 130 determines (134) which market segments to target. Process 130 identifies (135) opinion leaders in selected market segments. An opinion leader is viewed as “just like me” by other businesses in the market. Therefore, an early adopting opinion leader is the top priority in account development. Process 130 performs (136) a Camp development process. In a Camp development process, all marketing communications should amplify the successes of the opinion leader and lead the market by forming learning relationships with the opinion leader in each market. Process 130 generates (138) a product lifecycle. Process 130 is repeated periodically as required.

Process 130 is performed by a cross-functional team. The cross-functional team includes a VP/director of engineering, a VP/director of product development, VP/director of manufacturing, VP/director of research and development, VP/director of marketing, VP/director of customer service, VP/director of technical support, VP/director of documentation, VP/director of operations, and VP/director of finance.

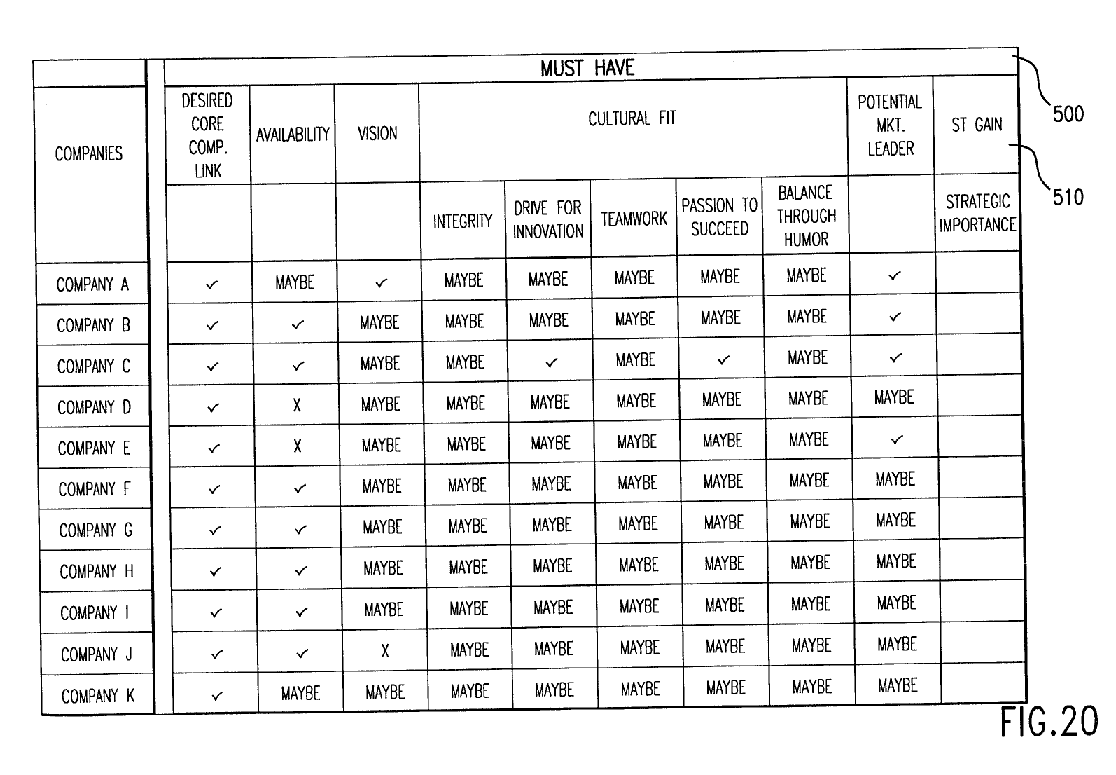

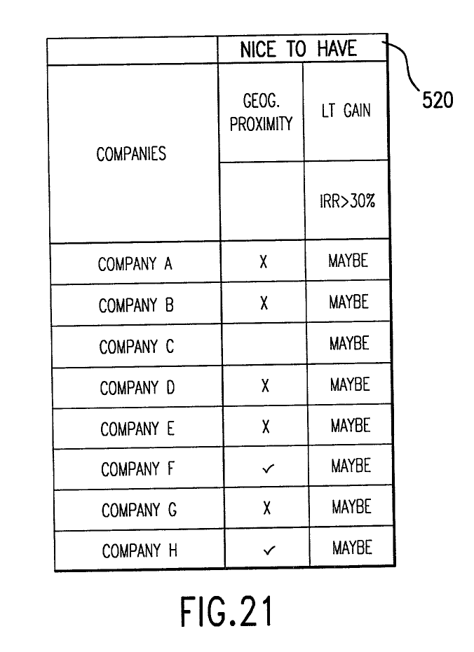

Referring to FIGS. 20-21, process 10 establishes (20) a market plan by determining which firms to target for merger or acquisition (FIG. 1). An exemplary implementation of determining the potential target firms is to use a target analysis. Target companies are characterized as either “must have” or “nice to have” by market segment. A “must have” company has certain attributes including the desired core competencies and has a shared vision with the business. The “must have” firm has other attributes such as the same culture and chemistry match, a potential to be first or second in the market, availability (no hostile takeovers) and short term wins for customers. A “must have” companies' attributes 510 are tabulated in a table 500. If a company has an attribute it is marked with a check. If it doesn't have the attribute it is marked with an “X.” If unsure a “maybe” is marked. “Nice to have” companies have long terms gains greater than, e.g., 30% internal rate of return and a close geographic proximity to the business. “Nice to have” characteristics are marked in a table 510 similar to check, x, or maybe process in table 500.

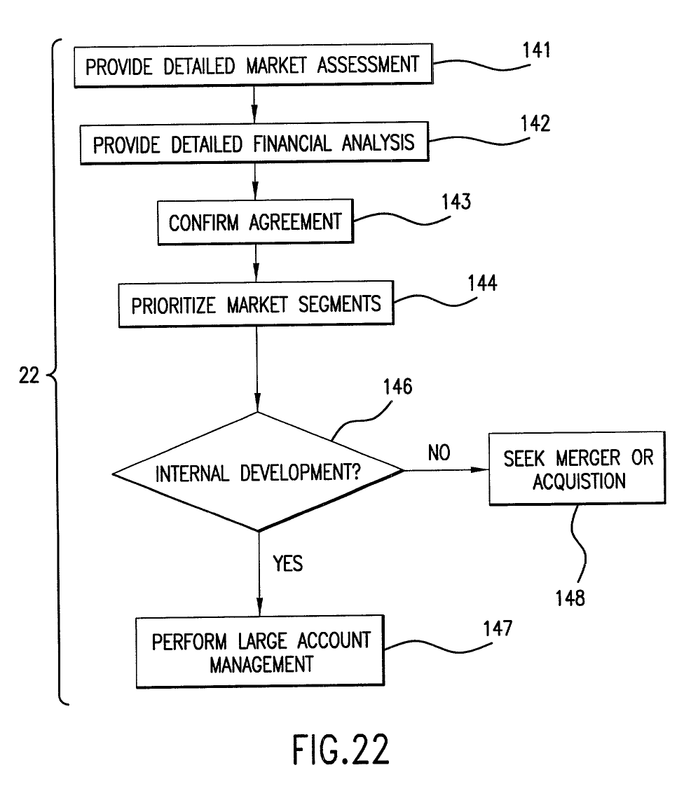

Referring to FIG. 22, process 10 prioritizes (22) a portfolio selection (FIG. 1). An exemplary implementation of prioritizing (22) includes using a detailed marketing plan and a financial analysis. Process 22 provides (141) a detailed market assessment plan for each market assessment. Each assessment includes a market overview, the business overview and strategy, market competition, market forecast and resource requirements. The market overview includes a definition, conditions, players and technologies, customers, barriers to entry, pricing, cost and market dynamics. The company overview and strategy include the business strategy, potential merger and acquisition targets, product strategy, patent portfolio, and goals and objectives. The market forecast includes timing of introduction, market units forecast by year, market revenue forecast by year and potential company market share. The resource requirements include a detailed capital requirements, a detailed personnel requirements and detailed support. Process 22 provides (142) a financial analysis for each market segment which includes a cumulative investment for five years, cumulative revenue for five years, cumulative profit for five years, payback time, internal rate of return (IRR) and net present value (NPV). Process 22 confirms (143) agreement of a detailed marketing plan for each segment with the industry trends, revenue pools, value proposition, values, mission, desired core competencies, market opportunity and profit pools. Process 22 prioritizes (144) the market segments based on the financials and provides a portfolio of markets/products. Process 22 determines (146) whether to do internal development or a merger or acquisition. A merger or acquisition is needed when the business lacks a necessary core competency and/or the market demand is greater than the available internal resources. If internal developments are determined, then process 22 performs (147) large account management. If internal development is not determined, then process 22 seeks (148) merger and acquisition.

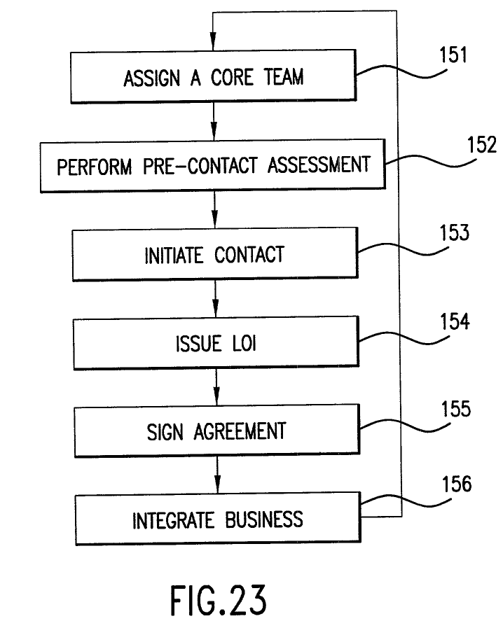

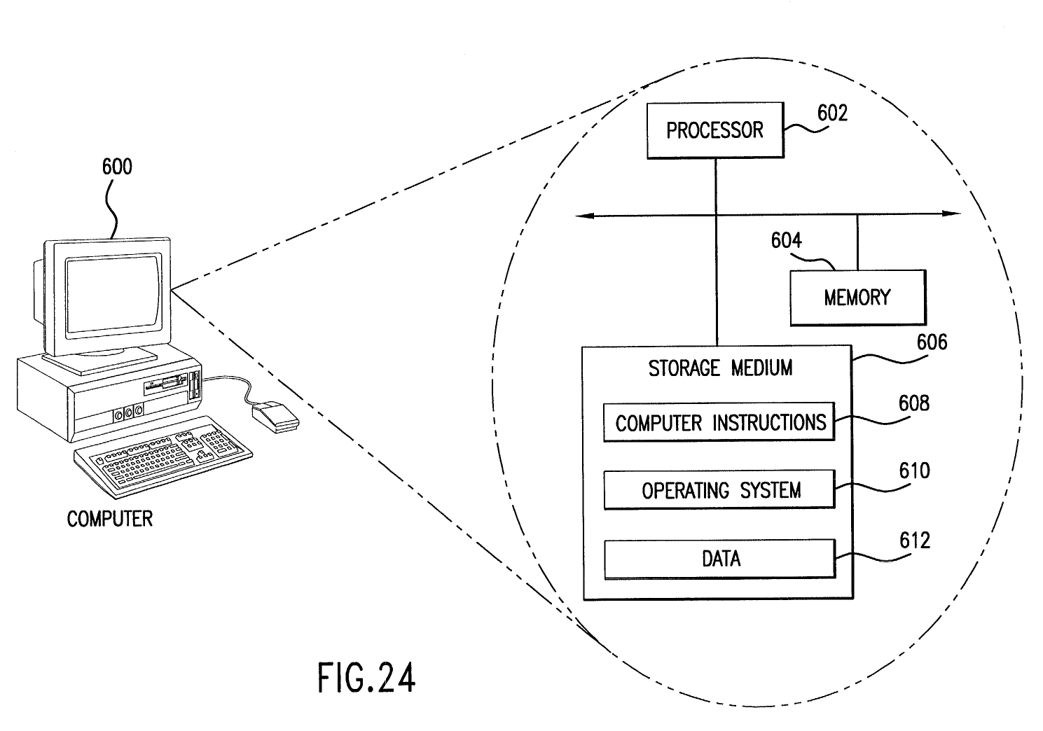

Referring to FIG. 23, process 10 implements (24) a course of action (FIG. 1). An exemplary implementation of implementing a course of action (24) by either merging and acquisition process or through internal development through large account management or both. Process 150 performs a merger and acquisition process. Process 150 assigns (151) a core team to handle acquiring a target business. The core team includes a VP/director of technology, a VP/director of marketing, VP/director of corporate development, VP/director of finance, VP/director of legal, an investment banker, VP/director of human resources, and a business analyst. Process 150 perform (152) a pre-contact assessment of the target business. Process 150 initiates (153) contact with the target business. Process 150 issues (154) a letter of intent. Process 150 signs (155) agreement with target business. Process 150 integrates (156) target business into the business. Process 150 is repeated periodically as required.

FIG. 23 shows a computer 600 for generating simulation code using process 10 for FIG. 23. Computer 600 includes a processor 602 for processing states, a memory 604, and a storage medium 606 (e.g., hard disk). Storage medium 606 stores operating system 610, data 612 for storing states, and computer instructions 608 which are executed by processor 602 out of memory 604 to perform process 10.

Process 10 is not limited to use with the hardware and software of FIG. 23; it may find applicability in any computing or processing environment and with any type of machine that is capable of running a computer program. Process 10 may be implemented in hardware, software, or a combination of the two. Process 10 may be implemented in computer programs executed on programmable computers/machines that each include a processor, a storage medium/article readable by the processor (including volatile and non-volatile memory and/or storage elements), at least one input device, and one or more output devices. Program code maybe applied to data entered using an input device to perform process 10 and to generate output information.

Each such program may be implemented in a high level procedural or objected-oriented programming language to communicate with a computer system. However, the programs can be implemented in assembly or machine language. The language may be a compiled or an interpreted language. Each computer program may be stored on a storage medium (article) or device (e.g., CD-ROM, hard disk, or magnetic diskette) that is readable by a general or special purpose programmable computer for configuring and operating the computer when the storage medium or device is read by the computer to perform process 10. Process 10 may also be implemented as a machine-readable storage medium, configured with a computer program, where upon execution, instructions in the computer program cause the computer to operate in accordance with process 10.

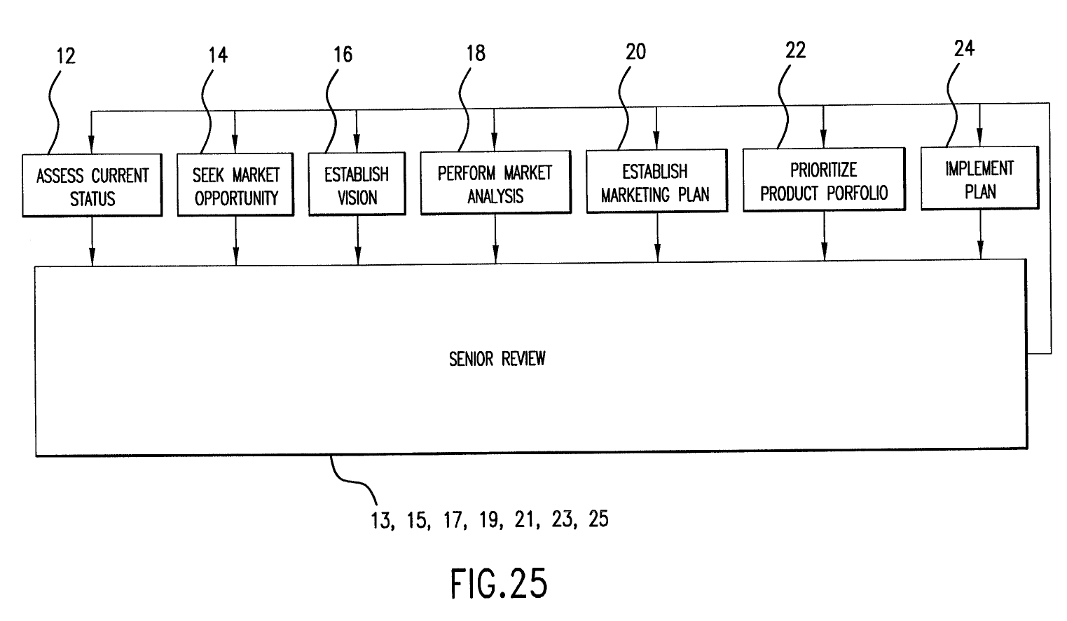

Referring to FIG. 25, the invention is not limited to the specific embodiments described herein. For example process 10 can be implemented using a parallel process instead of a sequential process. The invention is not limited to the specific processing order of FIGS. 1-4, 7-11, 15, 19, 22 and 23. Rather, the blocks of FIGS. 1-4, 7-11, 15, 19, 22 and 23 may be re-ordered, as necessary, to achieve the results set forth above. In addition, not all of the process actions need to be performed after each iteration but only as those steps are required due to changes in the business environment or in the business.

Other embodiments are also within the scope of the following claims.

We claim:

1. A method for strategic planning comprising:
assessing a current status of an entity to use as a basis to establish a development direction for the entity;
seeking opportunities for the entity in a market;
establishing a vision including a value proposition, a mission statement, and a set of desired core competencies;
performing an analysis of the market consistent with the vision to determine a set of profitable market segments from the opportunities;
establishing a marketing plan consistent with the vision to change the current status of the entity;
prioritizing a product portfolio based on the marketing plan; and
implementing a course of action consistent with the vision and the marketing plan, the course of action moving the entity from the current status to the development direction.

2. The method of claim 1 wherein seeking opportunities in the market comprises establishing a set of industry trends and a set of revenue pools.

3. The method of claim 1 wherein performing an analysis comprises generating a market opportunity map, profit pools and a general market assessment.

4. The method of claim 1 wherein establishing a marketing plan comprises focusing on the set of profitable market segments, the marketing plan including a detailed market assessment, a product life cycle and a target firm profile.

5. The method of claim 1 wherein prioritizing the product portfolio comprises using a set of financial criteria.

6. The method of claim 1, further comprising reviewing the vision, the opportunities, analysis of the market and the marketing plan by a senior staff.

7. The method of claim 1 wherein establishing a vision comprises determining the value proposition, determining a value proposition comprises:
determining a set of disciplines for each value proposition;
ranking the disciplines; and
determining the value proposition using a qualitative analysis.

8. The method of claim 1 wherein establishing a vision comprises establishing the mission statement, establishing the mission statement comprises:
analyzing a current direction of the entity;
laying a groundwork for a future direction for the entity;
encompassing an organizational culture into the mission statement that makes the mission statement clear and brief and directed to an audience that receives the mission statement; and
presenting the mission statement to the audience using a chosen suitable media.

9. The method of claim 1 wherein establishing a vision comprises determining the set of core competencies, determining the set of core competencies comprises:
determining the set of product core competencies based on a industry trend and a revenue pool;
performing an analysis to determine the set of desired product core competencies;
determining current level of the desired set of core competencies;
determining process core competencies based on the industry trends and the value proposition; and
prioritize the process core competencies.

10. The method of claim 1 wherein performing the analysis of the market comprises:
mapping market opportunities to form a market opportunity map;
determining a profit pool; and
performing a general market assessment.

11. The method of claim 10 wherein determining the profit pool comprises:
prioritizing each market identified in the market opportunity map;
determining five-year cumulative profits for a top market segment; and
re-prioritizing the market opportunity map based on the five-year cumulative profits.

12. The method of claim 1 wherein establishing a marketing plan comprises:
performing a detailed market analysis; and
measuring a product life cycle.

13. The method of claim 1 wherein prioritizing the product portfolio comprises using a checklist.

14. The method of claim 1 wherein implementing a course of action comprises conducting a merger and acquisition process, the merger and acquisition process includes:
assigning a core team;
performing a pre-contact assessment of an acquisition candidate;
initiating contact with the acquisition candidate;
issuing a letter of intent to the acquisition candidate;
performing a due diligence on the acquisition candidate;
signing an agreement with acquisition candidate; and
integrating the acquisition candidate into the business.

15. An apparatus comprising:
a memory that stores executable instructions for strategic planning; and
a processor that executes the instructions to:
assess a current status of an entity to use as a basis to establish a development direction for the entity;
seek opportunities for the entity in a market;
establish a vision including a value proposition, a mission statement, and a set of desired core competencies;
perform an analysis of the market consistent with the vision to determine a set of profitable market segments from the opportunities;
establish a marketing plan consistent with the vision to change the current status of the entity;
prioritize a product portfolio based on the marketing plan; and
implement a course of action consistent with the vision and the marketing plan, the course of action moving the entity from the current status to the development direction.

16. The apparatus of claim 15 wherein instructions to seek opportunities in the market comprises instructions to establish a set of industry trends and a set of revenue pools

17. The apparatus of claim 15 wherein instructions to perform an analysis comprises instructions to generate a market opportunity map, profit pools and a general market assessment

18. The apparatus of claim 15 wherein instructions to establish a marketing plan comprises instructions to focus on the set of profitable market segments, the marketing plan including a detailed market assessment, a product life cycle and a target firm profile.

19. The apparatus of claim 15 wherein instructions to prioritize the product portfolio comprises instructions to use a set of financial criteria.

20. The apparatus of claim 15, further comprising instructions to review the vision, the opportunities, analysis of the market and the marketing plan.

21. The apparatus of claim 15 wherein instructions to establish a vision comprises instructions to determine the value proposition, the instruction to determine the value proposition comprises instructions to:
determine a set of disciplines for each value proposition;
rank the disciplines; and
determine the value proposition using a qualitative analysis.

22. The apparatus of claim 15 wherein instructions to establishing the vision for the entity comprises instructions to establish the mission statement, instructions to establish the mission statement comprises instructions to:
analyze a current direction of the entity;
lay a groundwork for a future direction for the entity;
encompass an organizational culture into the mission statement that makes the clear and brief and directed to an audience that receives the mission statement; and
present the mission statement to the audience using chosen suitable media.

23. The apparatus of claim 15 wherein instructions to establish the vision comprises instructions to determine the set of core competencies, the instructions to determine the set of core competencies comprise instructions to:
determine the set of product core competencies based on a industry trend and a revenue pool;
perform an analysis to determine the set of desired product core competencies;
determine current level of the desired set of core competencies;
determine process core competencies based on the industry trends and the value proposition; and
prioritize the process core competencies.

24. An article comprising a machine-readable medium that stores executable instructions for strategic planning, the instructions causing a machine to:
assess a current status of an entity to use as a basis to establish a development direction for the entity;
seek opportunities for the entity in a market;
establish a vision including a value proposition, a mission statement, and a set of desired core competencies;
perform an analysis of the market consistent with the vision to determine a set of profitable market segments from the opportunities;
establish a marketing plan consistent with the vision to change the current status of the entity;
prioritize a product portfolio based on the marketing plan; and
implement a course of action consistent with the vision and the marketing plan, the course of action moving the entity from the current status to the development direction.

25. The article of claim 24 wherein instructions causing a machine to seek opportunities in the market comprises instructions causing a machine to establish a set of industry trends and a set of revenue pools

26. The article of claim 24 wherein instructions causing a machine to perform an analysis comprises instructions causing a machine to generate a market opportunity map, profit pools and a general market assessment

27. The article of claim 24 wherein instructions causing a machine to establish a marketing plan comprises instructions causing a machine to focus on the set of profitable market segments, the marketing plan including a detailed market assessment, a product life cycle and a target firm profile.

28. The article of claim 24 wherein instructions causing a machine to prioritize the product portfolio comprises instructions causing a machine to use a set of financial criteria.

29. The article of claim 24, further comprising instructions causing a machine to review the vision, the opportunities, analysis of the market and the marketing plan.

30. The article of claim 24 wherein instructions causing a machine to establish a vision comprises instructions causing a machine to determine the value proposition, the instructions causing a machine to determine the value proposition comprises instructions causing a machine to:
determine a set of disciplines for each value proposition;
rank the disciplines; and
determine the value proposition using a qualitative analysis.

31. The article of claim 24 wherein instructions causing a machine to establish the vision for the entity comprises instructions causing a machine to establish the mission statement, instructions causing a machine to establish the mission statement comprises instructions causing a machine to:
analyze a current direction of the entity;
lay a groundwork for a future direction for the entity;
encompass an organizational culture into the mission statement that makes the clear and brief and directed to an audience that receives the mission statement; and
present the mission statement to the audience using chosen suitable media.

32. The article of claim 24 wherein instructions causing a machine to establish the vision comprise instructions causing a machine to determine the set of core competencies, the instructions causing a machine to determine the set of core competencies comprise instructions causing a machine to:
determine the set of product core competencies based on a industry trend and a revenue pool;
perform an analysis to determine the set of desired product core competencies;
determine current level of the desired set of core competencies;
determine process core competencies based on the industry trends and the value proposition; and
prioritize the process core competencies.
